(19) United States
(12) Patent Application Publication
(10) Pub. No.: US 2016/0044580 A1
(43) Pub. Date: Feb. 11, 2016

(54) OVERLAPPING CHANNEL SCANS

(71) Applicants: Ayelet Alon, Herzliya, M (IL); Amir Rubin, Ramat Gan, M (IL)

(72) Inventors: Ayelet Alon, Herzliya, M (IL); Amir Rubin, Ramat Gan, M (IL)

(21) Appl. No.: 14/125,683

(22) PCT Filed: Aug. 27, 2013
(86) PCT No.: PCT/US13/56846

§ 371 Date: Mar. 5, 2015

(51) Int. Cl. H04W 48/16

(52) U.S. Cl. CPC H04W 48/16

(57) ABSTRACT

While scanning through various channels to find network controllers that are both within range and available, the scanning device may cover multiple channels simultaneously by using a bandwidth that encompasses multiple channels. This may be particularly useful with WiFi devices that are using the 2.4 GHz band, in which the channel spacing may be about 5 MHz, while the channel bandwidth may be about 22 MHz.

### BACKGROUND

Scanning (monitoring) for the presence of communication activity on specific channels is a common way for an unassociated wireless communication device to detect the presence of a nearby wireless network, which the scanning device may then decide to join. Even if a device is already associated with a network, it may use similar scanning techniques to detect available candidate controllers of current networks that may have a better connection or to detect and identify other nearby networks and to enable subsequent roaming from network to network. However, a device must remain active while scanning, which prevents it from going into an inactive low power mode to save battery power. Also, the scanning operation may conflict with other scheduled communication activities. Both problems axe detrimental to the performance of the device, and the reduction in performance tends to be proportional to the amount of time devoted to scanning. Many wireless networks are defined to include multiple channels, and the current practice of scanning each channel serially means the aforementioned problems are also proportional to the number of channels that are defined for each type of network being scanned. This problem may be especially noticeable when the number of channels available in a particular type of network is significant (for example, the WiFi 2.4 GHz band may have 14 channels).

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a mobile device and multiple network controllers, according to an embodiment of the invention.

FIG. 2 shows a wireless communication device, according to an embodiment of the invention.

FIG. 3 shows a spectrum diagram of multiple channels for the WiFi 2.4 GHz band, according to an embodiment of the invention.

FIG. 4 shows a flow diagram of a method of channel scanning, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all., or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information storage medium that may store instructions to perform operations and/or processes.

Various embodiments of the invention may be implemented fully or partially in software and/or firmware. This software and/or firmware may take the form of instructions contained in or on one or more computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Conversion from one form of code to another does not need to take place in real time, or by the processor that executes the code. Such a computer-readable medium may include any tangible non-transitory medium for storing information in a form readable by one or more computers, such as but not limited to read only memory (ROM); random access memory RAM); magnetic disk storage media; optical storage media; a flash memory, etc.

The term “wireless” may be used to describe circuits, devices, systems, methods, techniques, communications channels, etc., that communicate data by using modulated electromagnetic radiation through a non-solid medium. A wireless device may comprise at least one antenna, at least one radio, at least one memory, and at least one processor, where the radio(s) transmits signals through the antenna that represent data and receives signals through the antenna that represent data, while the processor(s) may process the data to be transmitted and/or the data that has been received. The processor(s) may also process other data which is neither transmitted nor received.

As used within this document, the term “network controller” is intended to cover devices that schedule and control, at least partially, wireless communications by other devices in the network. A network controller may also be known as a base station (BS), access point (AP), central point (CP), or any other term that may arise to describe the functionality of a network controller.

As used within this document, the term “mobile device” is intended to cover those devices whose wireless communications are at least partially scheduled and controlled by the network controller. A mobile device (MD) may also be known as a mobile station (MS), STA, subscriber station (SS), user equipment (UE), or any other term that may arise to describe the functionality of a mobile device. Mobile devices may move during such wireless communications, but movement is not required.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed.

As used within this document, the term ‘decodable wireless signal’ means that a received wireless signal is correctly transformed by the receiving device into the series of 1's and 0's that were intended, while the term ‘non-decodable wireless signal’ means that the received wireless signal is not correctly transformed in this manner by the receiving device. A signal may be non-decodable because it contains too many errors to be corrected within the receiver, or it may be non-decodable because the signal was too weak or the interference was too great to even produce a meaningful series of 1's and 0's. In some embodiments, the sensitivity and abilities of the receiving device may determine whether the signal is decodable or non-decodable.

As used within this document, a ‘channel’ means a wireless channel that has been designated by a standards group fbr shared use within an industry, and whose center frequency has been defined by that group. A ‘scan channel’ means a channel that has been selected by a wireless communication device for scanning (i.e., monitoring for a signal from another device). In some embodiments, the bandwidth of a scan channel may overlap, at least partially, other channels. This characteristic may make it possible for a device listening on one channel to receive and decode a signal that has been transmitted on another channel.

In various embodiments, a mobile device may transmit a probe request on a first channel and receive a response while listening on that first channel, even though the response identifies itself as having been transmitted on a second channel. This may be possible because the first and second channels overlapped sufficiently that the other device was able to receive and decode the probe request while listening on the second channel, and/or the mobile device was able to receive and decode the response while listening on the first channel. Since some types of transmissions identify the channel on which they are transmitted, the receiver may identify the channel of transmission, even though it was received on a different channel. This use of overlapping channels makes it possible to reduce the amount of time and energy devoted to scanning multiple channels.

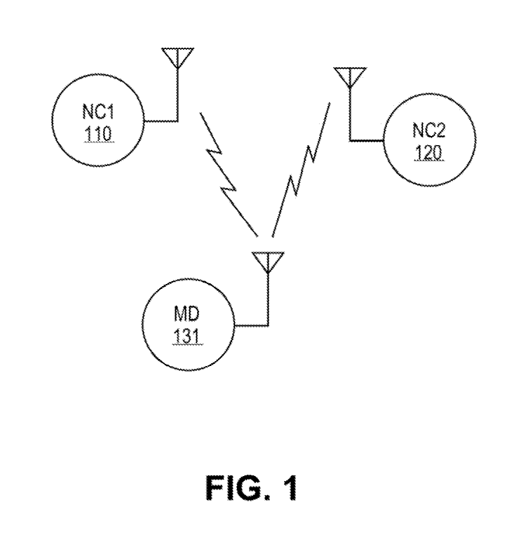

FIG. 1 shows a mobile device and multiple network controllers, according to an embodiment of the invention. Mobile device 131 (MD) is shown within communication range of network controller 110 (NC1) and network controller 120 (NC2). In the various embodiments described, MD may be unassociated with any network controller, or it may be associated with one of the illustrated network controllers, or it may be associated with a network controller not shown. For simplicity of explanation, only two network controllers are shown, but the functionality described herein may be extended to cover more than two network controllers. Any of the illustrated devices may also have other components not shown, such as but not limited to: 1) a display, 2) a keyboard, 3) a touch screen, 4) I/O connectors, 5) etc.

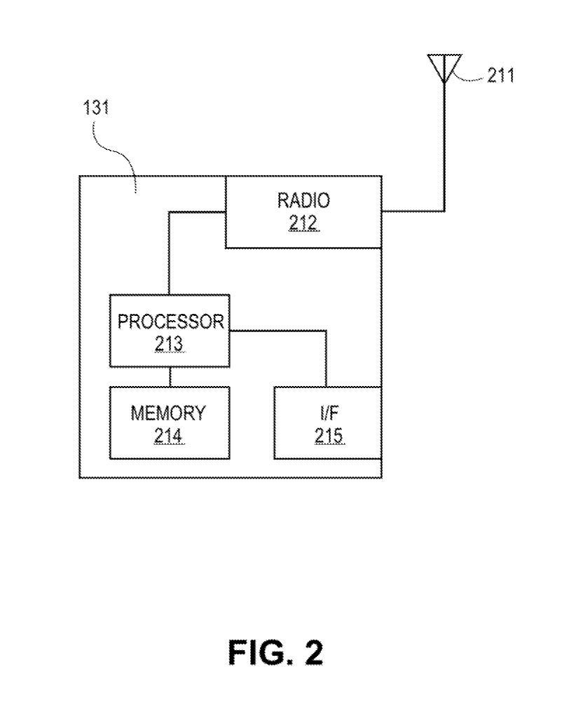

FIG. 2 shows a wireless communication device, according to an embodiment of the invention. Although the illustrated wireless communication device is labeled as mobile device 131, the same general configuration may be applied to a network controller or any other feasible wireless communication device. Mobile device 131 is shown with one or more antennas 211, one or more radios 212, one or more processors 213, one or more memories 214, and one or more user interfaces 215. These components may be coupled together in any feasible manner. In addition to the physical components shown, device 131 may also be configured into various functional components, such as software, a medium access control (MAC) layer, a physical medium access (PHY) layer, an application layer, and others. These will not be further described in this document unless such a description would increase an understanding of the various embodiments of the invention by a person of ordinary skill in the art.

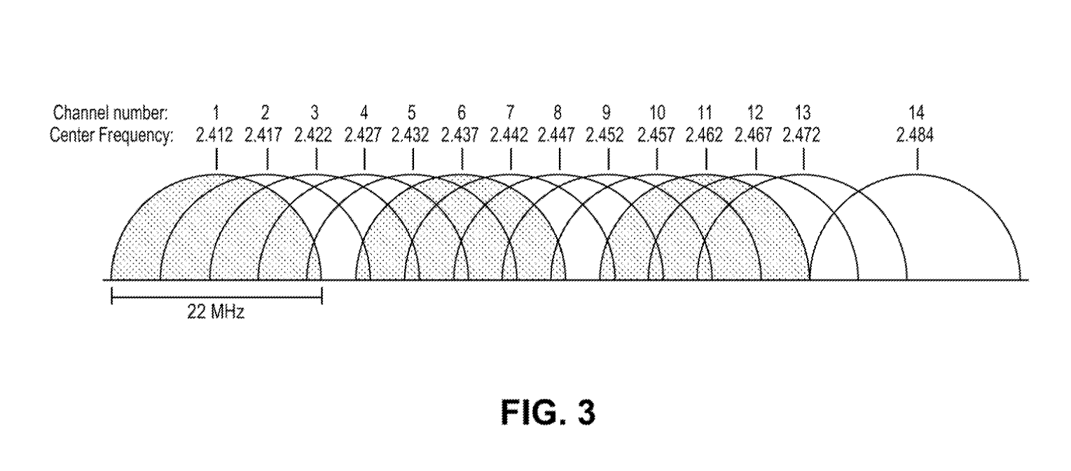

FIG. 3 shows a spectrum diagram of multiple channels, according to an embodiment of the invention. For ease of example, FIG. 3 shows fourteen channels that have been assigned by certain regulatory agencies for use in the unlicensed 2.4 GHz WiFi band, but the principles may be applied to other bands with other designated channels. As can be seen in this example, channels 1 through 13 are spaced at 5 MHz intervals (center-frequency-to-center-frequency, from 2.412 GHz to 2.472 GHz), with an additional channel 14 being spaced 12 MZ above channel 13. The semi-circle shown for each channel indicates the approximate bandwidth of each channel, which is shown as 22 MHz. As indicated, the bandwidth of each channel may partially overlap with the bandwidth of as many as 5 channels, implying that a receiver tuned to receive the entire 22 MHz bandwidth of a single channel may be able to detect transmissions on five different channels. Using this example, a device monitoring channel 3 may he able to detect transmissions on any of channels 1-5, a device monitoring channel 8 may be able to detect transmissions on any of channels 6-10, and a device monitoring channel 13 may he able to detect transmissions on any of channels 11-14. Thus, a device may be able to scan for transmissions on all 14 channels by selecting only those three channels as scan channels. This is just an example. Other scan channels and other overlapping may be used within the WiFi 2.4 GHz hand without departing, from the basic concept described.

Although this configuration of channels may make it possible to detect a transmission on one channel by listening on another channel, additional techniques may be necessary to convert this principal into useful information. For example, the scanning device may receive a communication that identifies the channel on which it was transmitted. If the channel identified in this manner is different than the channel on which it was received, the receiving device may know that this principal of overlapping channels was involved.

In some embodiments, when a scanning device selects a set of channels to scan, the scanning device may transmit a probe request on one of those channels and wait for a response identifying the responder and which channel the responder is using. If it receives no response within a predetermined time, it may select another set of channels to scan in a similar manner. If it does receive a response, that response may or may not be transmitted on the same channel as the probe request. In some instances, a single probe request may result in responses from multiple other devices. Since a response may identify both the identity of the device transmitting the response and its channel, this technique may allow the scanning device to identify all the network controllers that are within range and are also using one of the channels encompassed by the bandwidth of the selected scan channel. By repeating this process for each of the selected scan channels, the scanning device may be able to identify all network controllers using, any of the channels assigned to that band. This process allows the scanning device to know which networks it may he able to join and controllers it may prefer, should it decide to, while reducing the amount of scanning it must do to acquire that knowledge. With less time spent scanning, the device may be able to enter a low power inactive mode more often, thereby reducing battery consumption.

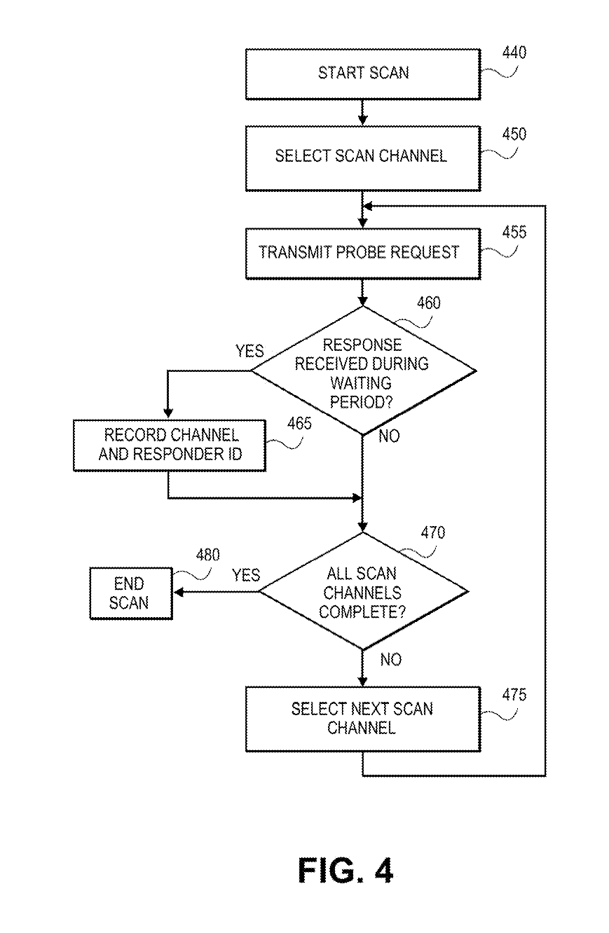

FIG. 4 show a flow diagram of a method of channel scanning, according to an embodiment of the invention. A channel scan procedure may begin at 440. At 450 the scanning device may select a scan channel by tuning its radio to that channel, and it may transmit a probe request on that channel at 455. The scanning device may then Wait for a response from one or more devices. To place a reasonable limit on how long the device waits for a response, a timer may be started at this point, and the device may wait for a response until the waiting period expires. Of course, the device may also engage in other activities while waiting, as long as it is still able to receive any relevant responses.

A response ma be a probe response, transmitted by another device in answer to the probe request. For the purposes of this document, a beacon may also be considered a response. Both beacons and probe responses contain the identification of the responder and the channel the response was transmitted on. Any probe response or beacon received at 460 during the waiting period may have their device identification and channel number recorded at 465. Although a beacon might not be transmitted in response to a probe request, if it's received during the waiting period and contains the needed information, it may be treated as a response for the purposes of this procedure.

Whether or not any responses were received during the waiting period, when the timer expires the device may stop monitoring for responses, and may determine at 470 whether scan channels have been covered. If not, another scan channel may be selected at 475, and the probe request and response cycle may be repeated. Once all the desired scan channels have been scanned, the scanning process may be ended at 480. The order in which the scan channels are selected may be based on any feasible criteria, such as but not limited to: 1) from lowest to highest frequency, 2) from highest to lowest frequency, 3) a history of most commonly used channels, 4) a history of recently used channels, 5etc. In some embodiments, only a portion of the possible scan channels may be scanned. In another embodiment, a first subset of available channels may be selected for a first scan operation, a second subset of available channels may be selected for a second scan operation, and the channels of the first subset may or may not overlap the channels of the second subset. The selection of which scan channels to scan, and when to scan them, may be made based on various criteria, most of which are beyond the scope of this document.

After the scanning operation has ended, the device may continue with other operations as needed, such as but not limited to: 1) communicating, 2) performing non-communication internal operations, 3) going into a low-power sleep mode, 4) etc. Typically, scanning operations may be repeated at intervals, either defined or adaptive, rather than being an ongoing process. The duration of those intervals may be determined in various ways, which are considered to be outside the scope of this document. But scanning operations may also be triggered by other events that don't have defined intervals.

Based on the information recorded at 465 about device IDs and channels, the scanning device may sort through this information and choose a controller to become associated with. This selection process might be done by a device that is currently unassociated, or might be done by a device that is looking for an improvement over its current association.

### EXAMPLES

A first example includes a method of wireless communication, comprising: transmitting a first probe request on a first channel;

receiving a first response, the first response identifying a first device transmitting the first response and identifying a second channel on which the first response was transmitted;

wherein the first channel is different than the second channel, the first channel has a bandwidth encompassing at least a part of the second channel, and the second channel has a bandwidth encompassing at least a part of the first channel.

A second example includes the first example, wherein the first response is either a probe response or a beacon.

A third example includes the second example, plus:

transmitting a second probe request on a third channel different than the first channel;

receiving a second response, the second response identifying a second device transmitting the second response and identifying a fourth channel on which the second response was transmitted;

wherein the third channel is different than the fourth channel, the third channel has a bandwidth encompassing at least a part of the fourth channel, and the fourth channel has a bandwidth encompassing at least a part of the third channel.

A fourth example includes the third example, wherein the second response is either a probe response or a beacon.

A fifth example includes the fourth example, wherein the first, second, third, and fourth channels each have a center frequency between 2.412 GHz and 2.484 GHz.

A sixth example includes the fourth example, wherein the first, second, third, and fourth channels each have a bandwidth of 22 MHz.

A seventh example includes a wireless communications device having a processor, a memory, and a radio, the device adapted to perform the operations of the first through sixth examples.

An eighth example includes a computer-readable non-transitory storage medium that contains instructions, which when executed by one or more processors result in performing, the operations described in any of the first through sixth examples.

The foregoing description is intended to be illustrative and not limiting. Variations will occur to those of skill in the art. Those variations are intended to be included in the various embodiments of the invention, which are limited only by the scope of the following claims. What is claimed is:

1. A method of wireless communication, comprising:
transmitting a first probe request on a first channel;
receiving a first response, the first response identifying a first device transmitting the first response and identifying a second channel on which the first response was transmitted;
wherein the first channel is different than the second channel, the first channel has a bandwidth encompassing at least a part of the second channel, and the second channel has a) o bandwidth encompassing at least a part of the first channel.

2. The method of claim 1, wherein the first response is either a probe response or a beacon.

3. The method of claim 2, further comprising:
transmitting a second probe request on a third channel different than the first channel;
receiving a second response, the second response identifying a second device transmitting the second response and identifying a fourth channel on which the second response was transmitted;
wherein the third channel is different than the fourth channel, the third channel has a bandwidth encompassing at least a part of the fourth channel, and the fourth channel has a bandwidth encompassing at least a part of the third channel.

4. The method of claim 3, Wherein the second response is either a probe response or a beacon.

5. The method of claim 4, wherein the first, second, third, and fourth channels each have a center frequency between 2.412 GHz and 2.484 GHz.

6. The method of claim 4, wherein the first, second, third, and fourth channels each have a bandwidth of 22 MHz.

7. A wireless communications device having a processor, a memory, and a radio, the device adapted to:
transmit a first probe request on a first channel;
receive a first response, the first response identifying a first device transmitting the first response and identifying a second channel on which the first response was transmitted;
wherein the first channel is different than the second channel, the first channel has a bandwidth encompassing at least a pan of the second channel, and the second channel has a bandwidth encompassing at least a pan of the first channel.

8. The wireless communications device of claim 7, wherein the first response is either a probe response or a beacon.

9. The wireless communications device of claim 8, further comprising:
transmitting a second probe request on a third channel different than the first channel
receiving a second response, the second response identifying a second device transmitting the second response and identifying a fourth channel on which the second response was transmitted;
wherein the third channel is different than the fourth channel, the third channel has a bandwidth encompassing at least a part of the fourth channel, and the fourth channel has a bandwidth encompassing at least a pan of the third channel.

10. The wireless communications device of claim 9, wherein the second response is either a probe response or a beacon.

11. The wireless communications device of claim 10, wherein the first, second, third, and fourth channels each have a center frequency between 2.412 GHz and 2.484 GHz.

12. The wireless communications device of claim 10, the first, second, third, and fourth channels each have a bandwidth of 22 MHz.

13. A computer-readable non-transitory storage medium that contains instructions, which when executed by one or more processors result in performing wireless communications operations comprising:
transmitting a first probe request on a first channel;
receiving a first response, the first response identifying a first device transmitting, the first response and identifying a second channel on which the first response was transmitted;
wherein the first channel is different than the second channel, the first channel has a bandwidth encompassing at least a part of the second channel, and the second channel has a bandwidth encompassing at least a part of the first channel.

14. The medium of claim 13, wherein the first response is either a probe response or a beacon.

15. The medium of claim 14, wherein the operations further comprise:
transmitting a second probe request on a third channel different than the first channel;
receiving a second response, the second response identifying a second device transmitting the second response and identifying a fourth channel on which the second response was transmitted;
wherein the third channel is different than the fourth channel, the third channel has a bandwidth encompassing at least a part of the fourth channel, and the fourth channel has a bandwidth encompassing at least a part of the third channel.

16. The medium of claim 15, wherein the second response is either a probe response or a beacon.

17. The medium of claim 16, wherein the first, second, third, and fourth channels each have a center frequency between 2.412 GHz and 2.484 GHz.

18. The medium of claim 16, wherein the first, second, third, and fourth channels each have a bandwidth of 22 MHz.
